(19) United States
(12) Patent Application Publication
(10) Pub. No.: US 2010/0250761 A1
(43) Pub. Date: Sep. 30, 2010

(54) Method for streaming shared media files with USB connected wireless media device

(76) Inventors: Dale Kyle Hird, Calgary (CA); Charalabos Diamantopoulos, Calgary (CA)

Correspondence Address: G.F. Gallinger, 7420 Milner Dr., Colorado Springs, CO, 80920, US

(21) Appl. No.: 12/383,689

(22) Filed: Mar. 26, 2009

(51) Int. Cl. G06F 15/173

(52) U.S. Cl. 709/231

(57) ABSTRACT

A method of downloading and playing a media file stored on a network computer, on a media player having a USB port to input data thereto, comprises the following steps: i) providing a streaming media device having USB wireless radio hardware including an embedded operating system, a controller, a basic input output system which controls the hardware and interfaces with the operating system, a caching system—controlled by the operating system, a data storage capability, and a USB port; ii) connecting the USB port of the player to the USB jack connected to the streaming media device; and, iii) selectively downloading a shared data file from the network computer to the streaming device connected to the media player. In another aspect of the invention the streaming media device is integrated within the media player and the above method deletes the step of designated ii) above.

### FIELD OF THE INVENTION

This invention relates to wirelessly selecting, downloading, and playing audio/video files. More particularly this invention relates to a wireless media device which is plugged into a USB port on an audio/video player, to view, and subsequently play a selected shared media file on a wireless network. A user is able to first view shared filenames, and then selectively stream and concurrently play, a selected media file stored anywhere on the network.

### BACKGROUND OF THE INVENTION

Most all audio/video players have minimal storage capabilities. Generally they can only play files stored on a disc, or cached in a flash drive. Through the internet, computers have access to almost every available title of song and videos. When individuals purchase music albums and videos, they generally download and store media files on their computer hard drives so that they can subsequently transmit, access, and re-access them. Presently there is no convenient means of linking the relatively vast libraries which individuals keep on their computers with the audio/video players that they use. In order to play a selection on a portable player, the selection must be first downloaded and stored onto a disk or flash drive. Then, only after the download is completed, and after the storage device has been moved to the player, is the user able to play the download on the player. The presence of a space consuming, deteriorating, dust collecting boxes, of titles in varying media formats is common. What is needed is a device which can facilitate access to, and subsequent download, and concurrent playing of titles directly from storage locations anywhere on a network.

### OBJECTS OF THE INVENTION

It is an object of this invention to disclose a convenient method of using a streaming media device. Media file folders stored on a networked computer are initially viewed from the media player. After a selection is made, data in the selected folder is subsequently streamed and concurrently played on the media player. When a selected media file is downloaded in real time as it is concurrently played, the present practice of downloading each title and file onto a secondary storage medium (not shown) prior to use, and subsequently locating, and moving that storage medium to the media player can be entirely eliminated. It is an object of this invention to eliminate the presence of a space consuming, deteriorating, dust collecting boxes, of both audio and video titles in varying media formats. It is yet a further object of this invention to save time and expense. It is yet a further object of this invention to disclose a more efficient and convenient method of organizing an enormity of audio and video mediums.

One aspect of this invention provides for a method of downloading and playing a media file stored on a network computer, on a media player having a USB port to input data thereto, comprises the following steps: i) providing a download media device having USB wireless radio hardware including an embedded operating system, a controller, a basic input output system which controls the hardware and interfaces with the operating system, a caching system—controlled by the operating system, a data storage means, and a USB port; ii) connecting the USB port of the player to the USB port of the download device; and, iii) selectively downloading a shared data file from the network computer to the streaming media device connected to the media player.

In another aspect of this invention a method of selecting, downloading, and playing an audio/video file stored on a network computer to a media player to input data thereto, comprising the following steps: i) providing a streaming media device having wireless radio hardware including an embedded operating system, a controller, a basic input output system which controls the hardware and interfaces with the operating system, a caching system—controlled by the operating system, a data storage means, wired into the media player; and, ii) selectively downloading a shared data file from the network computer to the streaming media device connected to the media player.

Various other objects, advantages and features of this invention will become apparent to those skilled in the art from the following description in conjunction with the accompanying drawings.

### FIGURES OF THE INVENTION

FIG. 1 is a schematic perspective view of a wireless media streaming device connected by a USB jack to a media player.

FIG. 2 is a schematic drawing of the wireless streaming media device shown in FIG. 1.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### DESCRIPTION OF THE INVENTION

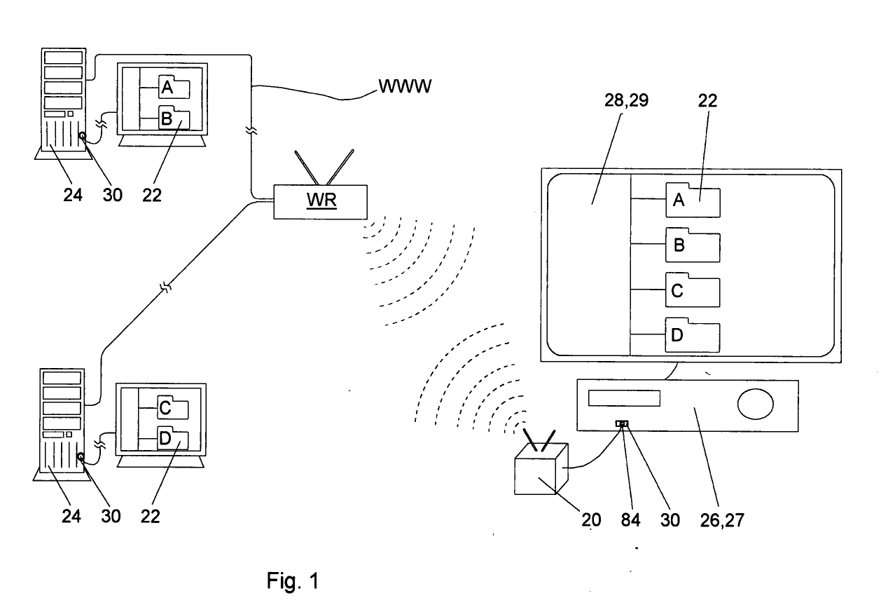

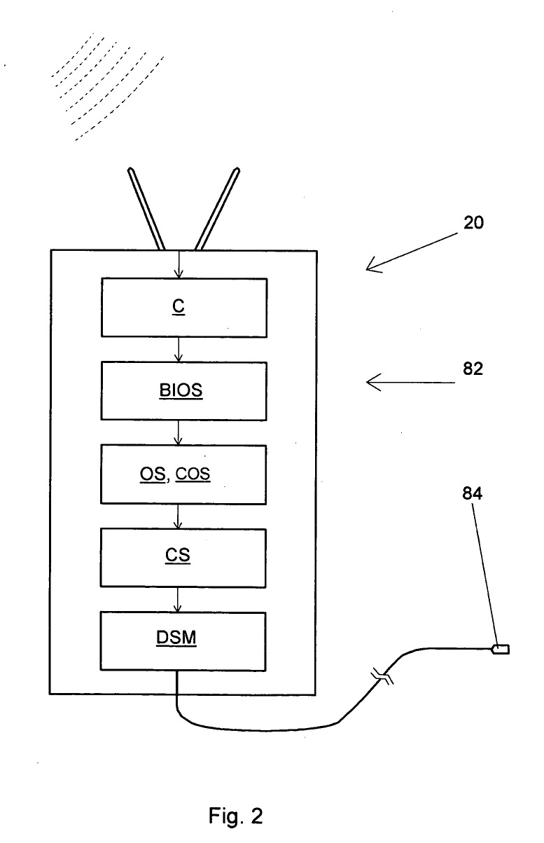

Turning now to the drawings and more particularly to FIG. 1 we have a schematic perspective view of a wireless router which is connected to the internet WWW and a network computer 24. As shown in FIG. 1 the network computer is intended to include a computer 24 on the internet. A wireless streaming media device 20 is wirelessly connected to the network computer 24. The wireless streaming media device 20 is also connected to media player 26 which is connected to a monitor 28. As shown in FIG. 1, most commonly the media player 26 is a DVD player 27 and the monitor 28 is a television 29. FIG. 2 is a schematic drawing of the wireless streaming media device 20 shown in FIG. 1.

Most generally a method of downloading and playing a media file 22 stored on a network computer 24, on a media player 26 having a USB port 30 to input data thereto, comprises the following steps: i) providing a streaming media device 20 having USB wireless radio hardware 82 including an embedded operating system OS, a controller C, a basic input output system BIOS which controls the hardware 82 and interfaces with the operating system OS, a caching system CS—controlled by the operating system OS, a data storage means DSM, and a USB jack 84; ii) connecting the USB port 30 of the player to the USB jack 84 connected to the wireless streaming media device 20; and, iii) selectively downloading a shared data file 22 from the network computer 24 to the streaming media device 20 connected to the player 26.

Within this specification a network computer 24 is intended and defined to include not only a computer networked in a local area network but additionally any computer or server which is interconnected, and is available to download from through the internet. Within this specification download is used in its broadest meaning which is “to transfer data”. Download is intended and defined to include not only a complete and maximally rapid transfer of a complete file but also a slower “streaming” transfer of a file in real time to a media player 26. Within this specification streaming is defined and intended to mean not only a relatively slow transfer of data necessitated by a lack of memory to store the complete file being transferred, but additionally a transfer of data where the transferred data is stored. A media player is defined and intended to include an audio player which downloads audio files and plays through loudspeakers.

Most preferably, the network computer 24 is connected to a wireless router WR. The streaming media device 20 is also wirelessly connected to the router WR. Most preferably the streaming media device 20 comprises a chip employing at least 802.11g/2.4 GHz wireless technology so that the requirement of high quality DVD media of about 3 Mbps is easily exceeded thereby facilitating download of media files 22 in real time thereby eliminating the necessity to download and store files in advance of playing. In the most preferred embodiment of the invention the media file folders 22 on the networked computer 24 can be first viewed, prior to making a selection therefrom, and downloading can be commenced from the media player 26.

In the most preferred embodiment of the invention wherein the operating system OS is a relatively small chip based system COS that will interact the basic input output system BIOS, present a web interface for configuration, and provide programming to virtually display file folders in the data storage means DSM. Most preferably the data storage means DSM has standard memory to hold actual data, as well as virtual data presentation means so that virtual data stored in a network folder 22 can be presented in the same fashion as actual data, thus allowing the download media device 20 to first read and then play the file folder contents in real time, as if the file folder and its contents actually resided in the data storage means DSM of the streaming media device 20.

In the most preferred embodiment of the invention the method further comprises the initial step of configuring the streaming media device 20 to the network by connecting the streaming media device 20 directly to a USB port 30 of one of the computers 24 in the network and then having a setup wizard walk the user through the initial configuration. A subsequent step comprises remote setup from the computer 24 after the download media device 20 is connected to the media player 26 by browsing to http://address-of-the-media device thereby accessing a web page to configure the device. The media device is effectively a node on the network.

The general method specified above can be adapted to provide for the streaming media device 20 being integrated within the media player 26. In this aspect of this invention a method of selecting, downloading, and playing a media file 22 stored on a network computer to a media player 26 to input data thereinto, comprising the following steps: i) providing a streaming media device 20 having wireless radio hardware. 82 including an embedded operating system OS, a controller C, a basic input output system BIOS which controls the hardware 82 and interfaces with the operating system OS, a caching system CS—controlled by the operating system OS, a data storage means DSM, wired into the media player 26; and, ii) selectively downloading a shared data file 22 from the network computer 24 to the media download device 20 connected to the player 26. This general method for the streaming media device 20 need be modified when the streaming media device 20 is integrated within the media player 26. The modified general method can be limited by the same limitations as specified above under the most general method.

While the invention has been described with preferred specific embodiments thereof, it will be understood that this description is intended to illustrate and not to limit the scope of the invention, which is defined by the following claims.

1. A method of downloading and playing a media file stored on a network computer, on a media player having a USB port to input data thereto, comprising the following steps:
i) providing a steaming media device having USB wireless radio hardware including an embedded operating system, a controller, a basic input output system which controls the hardware and interfaces with the operating system, a caching system—controlled by the operating system, a data storage means, and a USB jack;
ii) connecting the USB jack connected to the streaming media device to the USB port of the player; and,
iii) selectively downloading a shared data file from the network computer to the streaming media device connected to the player.

2. A method as in claim 1 wherein the computer is connected to a wireless router and wherein the streaming media device is wirelessly connected to the router.

3. A method as in claim 2 wherein the download media device comprises a chip employing at least 802.11g/2.4 GHz wireless technology so that the requirement of high quality DVD media of about 3 Mbps is easily exceeded thereby facilitating download of media files can be downloaded in real time thereby eliminating the necessity to download and store files in advance of playing.

4. A method as in claim 1 wherein the media file folders on the networked computer can be first viewed, prior to making a selection therefrom, and downloading can be commenced from the media player.

5. A method as in claim 1 wherein the operating system comprises a relatively small chip based system that will control the basic input output system, present a web interface for configuration, and provide programming to virtually display folders in the data storage means.

6. A method as in claim 5 wherein the data storage means has standard memory to hold actual data, as well as virtual data presentation means so that virtual data stored in a network folder can be presented in the same fashion as actual data, thus allowing the streaming media device to first read and then play the folder contents in real time, as if the folder and its contents actually resided in the data storage means of the streaming media device.

7. A method as in claim 1 further comprising the initial step of configuring the streaming media device to the network by connecting the streaming media device directly to a USB port of one of the computers in the network and then having a setup wizard walk the user through the initial configuration.

8. A method as in claim 7 wherein the initial setup comprises setting up wireless network security, and obtaining an IP address on the network.

9. A method as in claim 8 further comprising a subsequent step of remote setup from the computer after the streaming media device is connected to the media player by browsing to http://address-of-the-media device thereby accessing a web page to configure the device.

10. A method as in claim 9 further comprising the step of configuring network folders in the computer by adding a share name, username and password, and specifying the folder as audio/ video (or both) so that the streaming media device, having stand alone technology embedded therein, can be fully configured and updated in the media player.

11. A method of selecting, downloading, and playing an audio/video file stored on a network computer to a media player to input data thereto, comprising the following steps:
providing a streaming media device having wireless radio hardware including an embedded operating system, a controller, a basic input output system which controls the hardware and interfaces with the operating system, a caching system—controlled by the operating system, a data storage means, integrated into the media player; and,
selectively downloading a shared data file from the network computer to the streaming media device connected to the player.

12. A method as in claim 11 wherein the computer is connected to a wireless router and wherein the streaming media device is wirelessly connected to the router.

13. A method as in claim 12 wherein the streaming media device comprises a chip employing at least 802.11g/2.4 GHz wireless technology so that the requirement of high quality DVD media of about 3 Mbps is easily exceeded thereby facilitating download of media files in real time thereby eliminating the necessity to download and store files in advance of playing.

14. A method as in claim 11 wherein the media files on the networked computer can be first viewed, prior to making a selection therefrom, and downloading can be commenced from the media player.

15. A method as in claim 11 wherein the operating system is a relatively small chip based system that will control the basic input output system, present a web interface for configuration, and provide programming to virtually display folders in the data storage means.

16. A method as in claim 15 wherein the data storage means has standard memory to hold actual data, as well as virtual data presentation means so that virtual data stored in a network folder can be presented in the same fashion as actual data, thus allowing the streaming media device to first read and then play the folder contents in real time, as if the folder and its contents actually resided in the data storage means of the streaming media device.

17. A method as in claim 11 further comprising the initial step of configuring the streaming media device to the network by connecting the download media device directly to a USB port of one of the computers in the network and then having a setup wizard walk the user through the initial configuration.

18. A method as in claim 17 wherein the initial setup comprises setting up wireless network security, and obtaining an IP address on the network.

19. A method as in claim 18 further comprising the subsequent step of remote setup from the computer after the download media device is connected to the media player by browsing to http://address-of-the-media device thereby accessing a web page to configure the device.

20. A method as in claim 19 further comprising the step of configuring network folders in the computer by adding a share name, username and password, and specifying the folder as audio/ video (or both) so that the download media device, having stand alone technology embedded therein, can be fully configured and updated in the media player.
